(19) United States
(12) Patent Application Publication
(10) Pub. No.: US 2011/0252326 A1
(43) Pub. Date: Oct. 13, 2011

(54) SYSTEM FOR MONITORING/MANAGING INFORMATION LEAKAGE

(76) Inventor: Yoshihiro Asano, Tokyo (JP)

(21) Appl. No.: 12/281,670

(22) PCT Filed: Sep. 11, 2007
(86) PCT No.: PCT/JP2007/000989

§ 371 Date: Sep. 4, 2008

(30) Foreign Application Priority Data
Sep. 28, 2006 (JP) 2006-263833

(51) Int. Cl. G06F 3/01; G06F 15/16

(52) U.S. Cl. 715/736

(57) ABSTRACT

This invention concerns the system that is, for example, used to monitor information leakage. This invention can be used in a security system. The present invention is directed to store the change in an output screen as still images and sequentially displays them as screen images. In a system of the present invention, a plurality of terminals are monitored remotely by a monitoring/managing apparatus via a network. The terminal comprises an index data creation means, a difference data creation means, and a compression means. The monitoring/managing apparatus comprises a communication means, a picture-recording file creation means, a picture-recording file updating means, and a playback means. In addition, the index data creation means and the difference data creation means start processing based on an operation request.

### CROSS-REFERENCE TO RELATED APPLICATIONS

This application is based upon and claims the benefit of priority from prior Japanese Application No. 2006-263833, filed Sep. 28, 2006, the entire contents of which are incorporated herein by reference.

### BACKGROUND OF THE INVENTION

1. Field of the Invention

The present invention relates to a system for monitoring/managing information leakage from an information processor and can be used in a security system.

2. Discussion of the Related Art

Recently, for preventing information leakage, systems that monitor the transmission and reception of mail and the like, as well as systems that monitor operation histories are known (for example, see Patent Citation 1). In Patent Citation 1, a protection method using the operation history files of users that ensures security by monitoring intrusion to or destruction of a system in real time by acquiring the operation histories of the users who have logged-on to the network system until logout is described.
Patent Citation 1: JP-A-2000-354036

### BRIEF SUMMARY OF THE INVENTION

### Technical Problem

The method described in the above-mentioned document, however, is for monitoring the operation history performed by a user within a certain network system, and the method has a problem that the history is unknown when the user is not logged-on. Moreover, since the operation history is shown in text format, there is a problem that a system administrator has to read the text, which is the operation history of the user represented by characters, which is hard to understand at a glance.

Therefore, the present invention is directed to a system for monitoring/managing information leakage from an information processor that has stored the changes in an output screen as still images and that sequentially displays them as screen images, that monitors the output screen lowering the capacity required for the storage, and that monitors the output screen to manage information.

### Technical Solution

The present inventors have carried out extensive studies, and as a result, have accomplished the present invention.

A first aspect of the present invention provides a system comprising a plurality of terminals and a monitoring/managing apparatus, which monitoring/managing apparatus remotely monitors and management-controls the terminals via a network for monitoring/managing information leakage from the terminals. The terminals are information processors. The terminal of the system provided by the first aspect comprises the following means: an index data creation means that records an image of an entire output screen of the terminal as a full-screen still image at every index creation time and creates index data from the full-screen still image; a difference data creation means that records an image of the entire output screen of the terminal as a full-screen still image at every difference detection time, divides the full-screen still image that has just been recorded and the full-screen still image that was recorded immediately before into a predetermined number of sections and compares the respective sections with each other, determines presence or absence of change in image data of each section, and merely for the section in which the image data is changed, creates difference data of all the sections in which the image data is changed, the difference data having the image data of the section after the change, position information of the section, and data acquisition time information; and a compression means that compresses the index data and the difference data and saves them as compressed index data and compressed difference data, respectively. The terminal of the system may comprise, furthermore, an input event reflection means that causes the terminal to execute an operation order input from an input unit of the monitoring/managing apparatus and outputs a result thereof to the output screen of the terminal in real time. The monitoring/managing apparatus of the system, which is provided by the first aspect, comprises the following means: a communication means that transmits/receives data and transmits an operation request merely in one direction from the monitoring/managing apparatus to the terminal; a picture-recording file creation means that creates a picture-recording file for the every-compressed index data transmitted from the terminal to the monitoring/managing apparatus; a picture-recording file updating means that updates the picture-recording file by addition of the compressed difference data to the received picture-recording file, which is transmitted from the terminal to the monitoring/managing apparatus, to the picture-recording file so as to update the file; and a playback means that opens the picture-recording file and displays the output screen images of the terminal sequentially on the output screen of the monitoring/managing apparatus at one speed chosen from a plurality of display speeds by adjusting the display intervals. There is provided by the above system, wherein the index data creation means and the difference data creation means are being started, processing that is based on the operation request.

In the present invention, the “picture-recording file” includes a file having (an) image(s) composed of one or a plurality of still image(s).

Accordingly, the change in the output screen of the terminal can be stored as still images, the stored picture-recording file can be sequentially displayed as screen images in the output screen of the monitoring/managing apparatus, the capacity required for storage can be lowered, information management can be performed by monitoring the output screen of the terminal by the monitoring/managing apparatus, and the terminal can be controlled and managed by the monitoring/managing apparatus. As a result, information leakage from the terminals can be readily monitored/managed. Moreover, information leakage can be prevented by utilization of psychological effects on the users who use the terminals.

Furthermore, the monitoring/managing apparatus may include a searching means that searches a file in the terminal based on an operation order input from the input unit of the monitoring/managing apparatus and an editing means that edits a file in the terminal based on an operation order input from the input unit of the monitoring/managing apparatus. The editing means may include a first editing means that copies or deletes a file in the terminal or moves or pastes a file in the terminal to the terminal or to the monitoring/managing apparatus based on an operation order input from the input unit of the monitoring/managing apparatus and a second editing means that moves or pastes a file in the monitoring/managing apparatus to the terminal based on an operation order input from the input unit of the monitoring/managing apparatus. Accordingly, investigation of histories, such as the information acquisition state or information leakage state in the terminals, deletion of inappropriate files, addition of necessary files, and the others can be performed in the monitoring/managing apparatus side; therefore, more detailed information management of the terminals can be performed.

Moreover, a second aspect of the present invention provides a system that monitors/manages information leakage from an information processor, that internally monitors an output screen of the information processor, that manages information of the information processor, and that comprises: an index data creation means that records an image of an entire output screen as a full-screen still image at a predetermined time interval; a difference data creation means that records an image of the entire output screen as a full-screen still image at a predetermined time interval, divides the full-screen still image that has been just recorded and a full-screen still image that was recorded immediately before into a predetermined number of sections and compares the respective sections with each other, determines the presence or absence of change in image data of each section, and creates difference data by summing up the image data of merely the section in which the image data is changed; a compression means that compresses the index data and the difference data and saves them as compressed index data and compressed difference data, respectively; a picture-recording file creation means that creates a picture-recording file for the compressed index data; a picture-recording file updating means that updates the picture-recording file by addition of the compressed difference data to the picture-recording file; and a playback means that opens the picture-recording file and displays the output screen images sequentially on the output screen.

Accordingly, the change in the output screen of a computer of one's own can be stored as still images, the stored picture-recording file can be sequentially displayed as screen images in the output screen of the computer of one's own, the capacity required for the storage can be lowered, and information management can be performed by monitoring the output screen of one's own. Thus, monitoring/management of information leakage of the computer of one's own can be readily performed. Particularly, when one computer is used by a plurality of persons, the usage state can be managed. Moreover, information leakage can be prevented by the utilization of psychological effects on the users who use the computer.

A third aspect of the present invention provides an operation manual creating/distributing/viewing system, which creates an operation manual on a monitoring/managing apparatus, which distributes the manual to one or a plurality of terminals via a network, which views the manual on the terminal, and which comprises: a communication means that transmits/receives data between the terminal(s) and the monitoring/managing apparatus; an index data creation means that records an image of an entire output screen of the monitoring/managing apparatus as a full-screen still image at a predetermined time interval; a difference data creation means that records an image of the entire output screen of the monitoring/managing apparatus as a full-screen still image at a predetermined time interval, divides the said full-screen still image and a full-screen still image that is recorded immediately before into a predetermined number of sections and compares them with each other, determines the presence or absence of change in image data of each section, and creates difference data by summing up the image data of merely the section in which the image data is changed; a compression means that compresses the index data and the difference data and saves them as compressed index data and compressed difference data, respectively; a picture-recording file creation means that creates a picture-recording file for the compressed index data; a picture-recording file updating means that updates the picture-recording file by addition of the compressed difference data to the picture-recording file; and a playback means that opens the picture-recording file and displays the output screen of the monitoring/managing apparatus sequentially on the output screen of the terminal.

Accordingly, the change in the output screen of the monitoring/managing apparatus can be stored as still images, the stored picture-recording file can be sequentially displayed as screen images in the output screen of the terminal, and via a network by a monitoring/managing apparatus, the capacity required for storage can be lowered. Thus, a user can obtain a software operation manual or the like by sequential images in the user's output screen.

### Advantageous Effects

According to the present invention, the change in the output screen can be stored as still images, the stored picture-recording file can be sequentially displayed as screen images, the capacity required for storage can be lowered, and information management can be performed by monitoring the output screen.

### BRIEF DESCRIPTION OF THE DRAWINGS

FIG. 1 is an exemplary diagram showing a network configuration according to a first embodiment of the present invention.

FIG. 2 is an exemplary configuration diagram of the monitoring/managing apparatus according to a first embodiment of the present invention.

FIG. 3 is an exemplary configuration diagram of each of the terminals according to a first embodiment of the present invention.

FIG. 4 is an exemplary flow chart showing a picture-recording procedure according to the first embodiment of the present invention.

FIG. 5 is an exemplary explanatory diagram of an image recording method according to the first embodiment of the present invention.

FIG. 6 is an exemplary flow chart showing a remote procedure according to the first embodiment of the present invention.

FIG. 7 is an exemplary configuration diagram according to the second embodiment of the present invention.

### EXPLANATION OF REFERENCE

100 MONITORING/MANAGING APPARATUS

101 CPU

102 MEMORY

103 LAN BOARD

104 DISPLAY

105 KEYBOARD

106 MOUSE

107 OPERATING SYSTEM

110 MAGNETIC DISK

111 IMAGE FOLDER

112 MONITORING/MANAGING PROGRAM

200 TERMINAL

201 CPU

202 MEMORY

203 LAN BOARD

204 DISPLAY

205 KEYBOARD

206 MOUSE

207 OPERATING SYSTEM

210 MAGNETIC DISK

211 IMAGE FOLDER

213 OUTPUT SCREEN RECORDING/CONTROL PROGRAM

300 ROUTER

400 SERVER

500 COMPUTER

501 CPU

502 MEMORY

503 LAN BOARD

504 DISPLAY

505 KEYBOARD

506 MOUSE

507 OPERATING SYSTEM

510 MAGNETIC DISK

511 IMAGE FOLDER

512 MONITORING/MANAGING PROGRAM

513 OUTPUT SCREEN RECORDING/CONTROL PROGRAM

### DETAILED DESCRIPTION OF THE PREFERRED EMBODIMENTS

Hereinafter, regarding a system for monitoring/managing information leakage from an information processor of the present invention, the present invention will be described in detail by way of embodiments; however, the present invention is not limited thereto. A general architecture that implements the various features of the invention will now be described with reference to the drawings. The drawings and the associated descriptions are provided to illustrate embodiments of the invention and not to limit the scope of the invention.

### Mode for the Invention 1

The present embodiment is for remotely performing monitoring of one or a plurality of terminals by a monitoring/managing apparatus via a network for performing information management of the terminals and is for performing remote management by controlling the terminals via a network by a monitoring/managing apparatus as well, and the embodiment is effective, for example, for an administrator to monitor and manage the operation state, information input/output state, and so on of personal computers of company members at various locations connected by a network.

### Configuration According to a First Embodiment of the Present Invention

In a system of the present embodiment wherein the monitoring/managing apparatus monitors and manages the terminal of the user, a communication means or unit, an index data creation means or unit, a difference data creation means or unit, and a compression means or unit are in the terminal of a user; and a communication means, a picture-recording file creation means or unit, a picture-recording file updating means or unit, a playback means or unit, an input event reflection means or unit, and an editing means or unit are in the monitoring/managing apparatus in the monitoring/managing side.

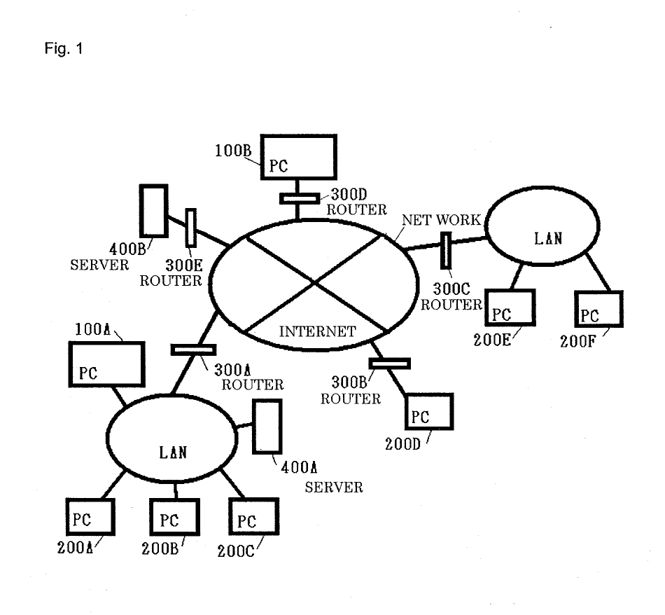

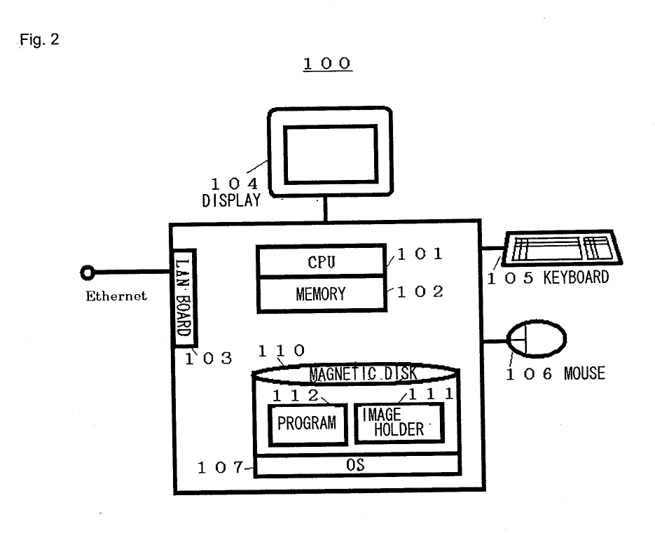

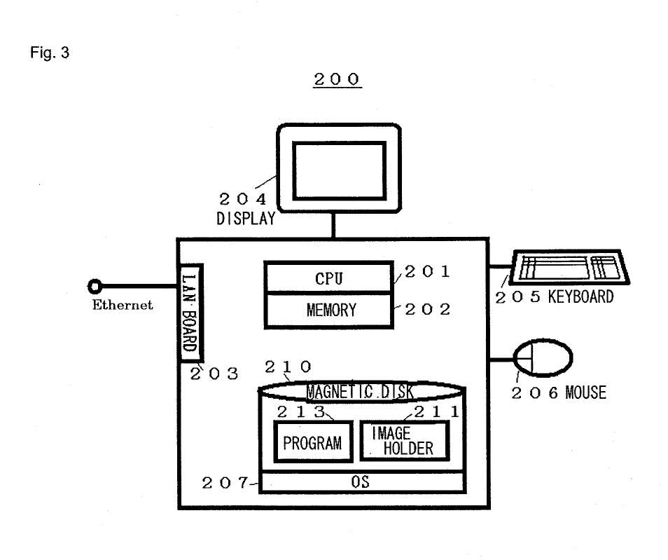

FIG. 1 is an exemplary diagram showing a network configuration of the system for monitoring/managing information leakage from an information processor according to a first embodiment of the present invention. FIG. 2 is an exemplary configuration diagram of the monitoring/managing apparatus of the system for monitoring/managing information leakage from an information processor according to a first embodiment of the present invention. FIG. 3 is an exemplary configuration diagram of each of the terminals of the system for monitoring/managing information leakage from the terminal according to a first embodiment of the present invention. The terminals are information processors. In the first embodiment, monitoring/managing apparatuses 100 and the terminals 200 are connected via a computer network. Both the monitoring/managing side and the side to be monitored/managed are connected by protocol called Ethernet. The monitoring/managing apparatus can perform remote monitoring/management not only in the case in which the terminals to be managed are present within the same LAN (local area network) but also when they are connected via a WAN (world area network) in which LANs are mutually connected by dedicated lines or when they are connected via the Internet as long as they are connected to a network via routers.

FIG. 1 shows that the monitoring/managing apparatuses 100 can monitor/manage not only the terminals connected by a LAN but also those connected by other networks.

The data transmitted to the monitoring/managing apparatuses 100 from the terminals 200 of the side to be monitored/managed may be accumulated in servers 400, which is set so that the server cannot be accessed from the terminals 200, and the data may be retrieved by the monitoring/managing apparatuses 100, if required.

A monitoring/managing apparatus 100A, terminals 200A, 200B, and 200C, and a server 400A are mutually connected by a LAN. The LAN is connected to the Internet via a router 300A. In addition, a terminal 200D is connected to the Internet via a router 300B, and terminals 200E and 200F are connected in another LAN, which is connected to the Internet via a router 300C. Furthermore, a monitoring/managing apparatus 100B is connected to this Internet via a router 300D, and a server 400B, which is placed via a router 300E, is present in the Internet.

The monitoring/managing apparatus 100A can monitor/manage the terminals 200A to 200F. The monitoring/managing apparatus 100B can also monitor/manage the terminals 200A to 200F. An output screen recording/control program is loaded in the computer of the side to be monitored/managed, and a monitoring/managing program is loaded in the computer on the monitoring/managing side.

In the present embodiment, a program of the system for monitoring/managing information leakage from the terminal includes the output screen recording/control program that operates on the terminal used by a user and the monitoring/managing program that operates on the monitoring/managing apparatus used by an administrator.

The output screen recording/control program is a program for realizing, in a computer: a function of establishing connection with the monitoring/managing apparatus; a function of recording the image of the entire output screen of the terminal as a full-screen still image at a predetermined time interval in accordance with a request from the monitoring/managing apparatus and creating index data; a function of recording the image of the entire output screen of the terminal as a full-screen still image at a predetermined time interval in accordance with a request from the monitoring/managing apparatus, dividing a full-screen still image that has just been recorded and a full-screen still image that was recorded immediately before the same into a predetermined number of sections, and comparing the respective sections of the former full-screen still image and those of the latter full-screen still image with each other in a section-to-section manner; a function of determining the presence or absence of change of the image data for each section; a function of calculating the image data of merely the sections of which image data is changed and creating difference data; a function of compressing and saving created index data; a function of compressing and saving created difference data; a function of transmitting the compressed data to the monitoring/managing apparatus; and a function of executing an operation order input from an input unit of the monitoring/managing apparatus as an operation order input from an input unit of the terminal and outputting the result, to which the result thereof is reflected, to the output screen. When the executing is unnecessary, the output screen recording/control program may be without the function of executing.

The monitoring/managing program is a program for realizing, in a computer: a function of establishing connection with the terminal; a function of transmitting an output screen recording request to the terminal; a function of receiving data from the terminal; a function of creating a picture-recording file from compressed index data; a function of updating the picture-recording file by addition of the compressed difference data to the picture-recording file; a function of opening the picture-recording file and sequentially displaying picture-recording images in an output screen; a function of transmitting the operation order from the input unit to the terminal as an operation order; and a function of searching/editing a file in the terminal.

In order to monitor/manage, the monitoring/managing apparatus side is required to be provided with access authority to the computer of the side to be managed. Authentication of access authority is carried out by an ID and password.

The user who uses the terminal is not required to input a password or the like for connection with the monitoring/managing apparatus, and all actions of connection, picture-recording, playback, remote operations, searching, uploading, and downloading can be performed by operations in the monitoring/managing apparatus side. Therefore, monitoring/managing can be carried out without letting the user know that the user is being monitored/managed. In addition, the user can be informed about the operation by displaying the monitoring/managing condition in the output screen of the terminal.

The computer in the side to be managed is recognized by the IP address and port number of a router. When the computer in the side to be managed is connected to the Internet via a LAN, the IP address of the router connecting the LAN network with the Internet network and a port number allocated to the computer in the LAN are used. When the side to be managed and the managing side are connected by the Internet or a WAN, the port number of a router between them is caused to be “valid” in order to perform monitoring/management for the reason that a hole has to be punched in the router. In other words, a particular port has to be permitted.

In the present embodiment, for example, the port numbers of the terminals 200A, 200B, and 200C in the LAN are 1001, 1002, and 1003, respectively. The port number of the terminal 200D is 1001, the port number of the terminals 200E and 200F in the LAN are 1001 and 1002, respectively, and the IP addresses of the routers 300A, 300B, 300C, and 300D are (2xx. xx. 01), (2xx. xx. 02), (2xx. xx. 03), and (20xx. xx. 04), respectively. Note that “x” of the IP addresses herein is a predetermined number. Therefore, for example, when the computer of the side to be managed is the terminal 200A, the computer is recognized by the IP address (2xx. xx. 01) and the port number 1001.

The monitoring/managing apparatus 100 checks the IP address and the port number of each computer of the side to be managed and acquires each computer name through the connection using the IP address and the port number. Even when a WAN is provided between the monitoring/managing apparatus and the terminals, as long as the port number of each router is “valid,” the setting of each router of the terminal side can be set from the monitoring/managing apparatus 100, and allocation setting of global IP addresses and private IP addresses can be carried out. Therefore, even when the address of the computer that is PC (personal computer) within the LAN is changed, the computer of the side to be managed can be recognized; thus, monitoring/management can be carried out. Allocation setting or the like of global IP addresses and private IP addresses is not required in the terminal side, monitoring/managing can be carried out even when the address of a PC within a LAN is converted through utilization of a broadband router or the like, and monitoring/managing can be carried out even when the PC operating ability of the user is at the level that the user cannot carry out various settings.

When the location of the computer on the managing side is limited in the same LAN as the computer of the side to be managed, recognition may be carried out by the local IP address and the port number of the computer of the side to be managed.

In the present embodiment, both the monitoring/managing apparatuses 100 and the terminals 200 are composed as personal computers and provided with a clock function or the like that a normal personal computer has. The clock function is a time determination means.

The monitoring/managing apparatus 100 has, as hardware, a control device comprising a CPU (central processing unit) 101, a memory 102, a display 104, a keyboard 105, a mouse 106, an operating system 107, a device driver, and others, as well as having secondary storage, such as a magnetic disk 110, and a communication control device, such as a LAN board 103. The magnetic disk 110 stores the monitoring/managing program 112, an image folder 111, an authentication database, and an environment-setting folder. In the image folder 111, picture-recording files are accumulated. In the authentication database, IDs, passwords, and port numbers and IP addresses of one or more of the terminals to be monitored/managed are accumulated. In the environment-setting folder, setting condition data, such as index data creation intervals and difference data creation intervals of the output screen of the terminal(s) and the size for dividing images upon difference data creation are accumulated. The monitoring/managing apparatus 100 realizes the functions of the computer that can carry out information leakage monitoring/managing processes of the present invention by loading the monitoring/managing program to the memory and executing it by the CPU 101. The CPU 101 is an arithmetic processing unit, which is loaded on a normal computer, executes various programs, and performs various controls or the like.

The terminal 200 has, as hardware, a control device comprising a CPU 201, a memory 202, a display 204, a keyboard 205, a mouse 206, an operating system 207, a device driver, and others, as well as having secondary storage, such as a magnetic disk 210, and a communication control device, such as a LAN board 203. The magnetic disk 210 stores the output screen recording/control program 213, an image folder 211, and an authentication database. In the image folder, output screen images, index data, difference data, compressed index data, and compressed difference data are accumulated. In the authentication database, IDs of the monitoring/managing apparatus that manages the terminal 200 are stored. The terminal 200 realizes the functions of the computer that can carry out information leakage monitoring/managing processes of the present invention by loading the output screen recording/control program 213 to the memory 202 and executing it by the CPU 201. The CPU 201 is an arithmetic processing unit, which is loaded on a normal computer, executes various programs, and performs various controls or the like.

The server 400 has, as hardware, a control device comprising a CPU, a memory, an operating system, a device driver, and the like, as well as secondary storage, such as a magnetic disk, and a communication control device, such as a LAN board. The magnetic disk stores an image folder. In the image folder, picture-recording files are accumulated. The server 400 serves as a file server.

In the present embodiment, the monitoring/managing apparatus 100 is provided with: (1) a transmission means of transmitting communication requests including operation requests and data to the terminals 200; (2) a reception means of receiving compressed index data and compressed difference data of the terminals 200; (3) a picture-recording file creation means of creating a picture-recording file from the compressed index data received; (4) a picture-recording file updating means of updating the picture-recording file by adding the compressed difference data received to the picture-recording file; (5) a playback means of opening the picture-recording files and sequentially displaying the output screen images of the terminals 200 in the output screen of the monitoring/managing apparatus 100; (6) a search means or unit of searching a file in the terminal 200 based on an operation order input from the input unit of the monitoring/managing apparatus 100; and (7) an editing means of editing a file in the terminal 200 based on an operation order input from the input unit of the monitoring/managing apparatus 100. The editing means has a first editing means and a second editing means. The first editing means copies or deletes a file in the terminal 200, or moves or pastes a file in the terminal within the terminal 200 or into the monitoring/managing apparatus 100 based on an operation order input from the input unit of the monitoring/managing apparatus 100. And, a second editing means moves or pastes a file in the monitoring/managing apparatus 100 into the terminal 200 based on an operation order input from the input unit of the monitoring/managing apparatus 100. The transmission means and the reception means are communication means. The monitoring/managing apparatus 100 functions as the above-described means (1) to (7) by the above-described hardware configuration and the monitoring/managing program 112.

The picture-recording files created in the monitoring/managing apparatus 100 are saved in the monitor/managing apparatus 100. In the case when the capacity in the monitoring/managing apparatus 100 is not enough, the files may be saved in the server 400. In that case, preferably, the monitoring/managing apparatus 100 further has (8) a picture-recording file transmitting means that transmits the created picture-recording file to the specified server 400 and (9) a picture-recording file searching and receiving means that searches and receives a picture-recording file accumulated in the server 400. The monitoring/managing apparatus 100 functions as these means by the above-described hardware configuration and the monitoring/managing program 112.

Also, the terminal 200 is provided with: (1) a reception means of receiving communication requests, including operation requests from the monitoring/managing apparatus 100 and data; (2) an index data creation means of recording the image of the entire output screen of the terminal 200 as a full-screen still image at every predetermined time and creates index data from the full-screen still image; (3) a difference data creation means of recording the image of the entire output screen of the terminal 200 as a full-screen still image at every predetermined time, dividing a full-screen still image, that has just been recorded, and a full-screen still image, that was recorded immediately before, into a predetermined number of sections, and comparing them with each other, determining the presence or absence of change of the image data for each section, and creating difference data by summing up the image data of merely the section in which the image data is changed; (4) a compression means of compressing the index data and the difference data and saving the same as compressed index data and compressed difference data, respectively; (5) a transmission means of transmitting the compressed index data and the compressed difference data to the monitoring/managing apparatus 100 in real time corresponding to an operation request from the monitoring/managing apparatus 100; and (6) an input event reflection means of updating the output screen of the terminal 200 in real time based on an operation order input from the input unit of the monitoring/managing apparatus 100. The transmission means and reception means are the communication means. The terminal 200 functions as the above-described means (1) to (6) by the above-described hardware configuration and the output screen recording/control program 213.

### Procedure According to a First Embodiment of the Present Invention

A picture-recording procedure of a first embodiment of the system of the present invention will next be described. The system is for monitoring/managing information leakage from the terminals. The monitoring/managing apparatus is capable of monitoring/managing a plurality of terminals at the same time. As an example of the case in which the terminals 200A to 200F are monitored/managed by the monitoring/managing apparatus 100A, the case in which the terminal 200A serves as a monitoring/managing object will be described. Although the picture-recording file may be saved in the server 400A or the server 400B as the accumulation destination thereof, the case in which the file is saved in the monitoring/managing apparatus 100A will be described as an example.

(Starting Procedure)

First of all, the control device of the monitoring/managing apparatus displays an authentication ID input requesting screen as an initial screen in the display 104 serving as an output screen and accepts input from an administrator. When the administrator inputs an ID via a mouse 106 or a keyboard 105, which is an inputting means, the control device accesses the authentication database and confirms whether there is the ID or not. When the ID is confirmed, the monitoring/managing apparatus displays a password input screen and accepts input from the administrator. When the administrator inputs a password, the control device accesses the authentication database and confirms whether the password is correct or not.

When it is confirmed that the password is correct, log-in is carried out, a first menu screen for selecting <Change ID/Password>, <List of Terminals>, <Environment Setting>, and <Logout> is displayed in the display 104 and accepts command from the administrator. When the administrator selects <Change ID/Password>, a screen for changing the ID and password is displayed. When the administrator selects <Environment Setting>, the monitoring/managing apparatus displays a screen for confirming/changing settings, such as the index data creation interval and difference data creation interval of the output screen of the terminal and the size for dividing the image upon difference data creation. When the administrator selects <Logout>, the monitoring/managing apparatus finishes processing.

For example, it is assumed that the administrator selects <List of Terminals>. The control device accesses the communication control device to acquire the connection status, accesses the authentication database to acquire a list of terminals that are monitored/managed objects, and displays a list of the port numbers, IP addresses, and the connection status of the terminals.

For example, in the field of the terminal 200A, the port number 100 and an IP address 202. 10. 0. 1 are displayed. The same contents are displayed as the IP addresses in the fields of the terminals 200B and 200C. In the field of the terminal 200F, the port number 1002 and an IP address 202. 10. 0. 3 are displayed. The terminals 200D and 200E are also displayed in a similar manner. In the field of the connection status, the connection state of the terminals and the monitoring/managing apparatus is displayed. When the power of the terminal is not turned on or when connection is not required, the fact that connection is not established is displayed.

For example, it is assumed that the administrator selects the field of the terminal 200A. The control device displays a second menu screen for selecting <Display Log>, <Remote>, <Search and Upload/Download>, <Start Picture-Recording>, and <Stop Picture-Recording> in the display and accepts a command from the administrator.

(Picture-Recording Procedure)

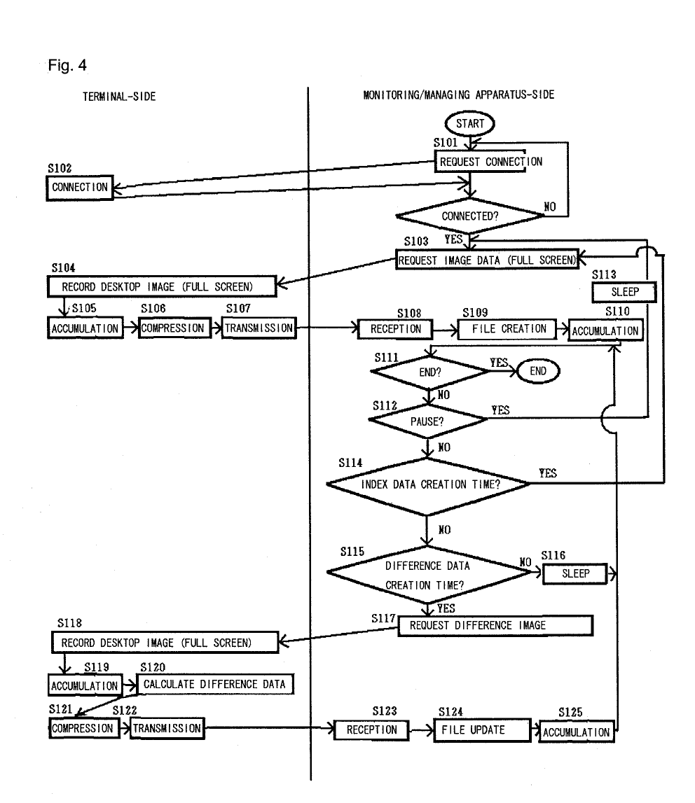

It is assumed that the administrator selects <Start Picture-Recording>. Hereinafter, it will be explained with reference to the drawings. FIG. 4 is a flow chart showing a picture-recording procedure of the first embodiment of the system of the present invention. The system is for monitoring/managing information leakage from the terminals. The picture-recording procedure includes: a step of connecting the monitoring/managing apparatus with the terminal by the communication means, which transmits/receives data of the terminal and the monitoring/managing apparatus and operation requests from the monitoring/managing apparatus to the terminal (S101, S102); a step of recording and accumulating the image data of the entire output screen of the terminal at every index creation time by the index data creation means, which records the image of the entire output screen of the terminal as a full-screen still image at a predetermined time interval (S103 to S105); a step of compressing and saving index data by the compression means, which compresses the index data and difference data and saves it as compressed index data and compressed difference data, respectively (S106); a step of transmitting the compressed index data from the terminal to the monitoring/managing apparatus by the communication means (S107); a step of causing the monitoring/managing apparatus to receive the compressed index data from the terminal by the communication means (S108); a step of creating and accumulating a picture-recording file by the picture-recording file creation means, which creates the picture-recording file (S109 to S110); a step of determining whether it is data acquisition time by a time determination means, which is the clock function (S111 to S116); a step of requesting a difference image to the terminal by the communication means; a step of creating and accumulating difference data of the output screen of the terminal at every difference detection time by the difference data creation means, which records the image of the entire output screen of the terminal as a full-screen still image at a predetermined time interval, divides the full-screen still image that has been just recorded and a full-screen still image that was recorded immediately before into a predetermined number of sections, compares them with each other, determines the presence or absence of change of the image data for each section, and calculates image data of merely the section in which the image data is changed to provide difference data (S118 to S120); a step of compressing and saving the difference data by the compression means (S121); a step of transmitting the compressed difference data from the terminal to the monitoring/managing apparatus by the communication means (S122); and a step of causing the monitoring/managing apparatus to receive the compressed difference data from the terminal by the communication means and updating and accumulating the picture-recording file by the picture-recording file updating means, which adds the compressed difference data to the picture-recording file so as to update the file (S123 to S125). The program of the system for monitoring/managing information leakage from the terminal having the output screen recording/control program and the monitoring/managing program causes the computers to execute these steps.

The index creation time and the difference detection time can be set when the administrator performs input in <Environment Setting>; for example, the index data creation time may be set as every one hour, and the difference detection time can be set as every three seconds. The index data creation time interval is preferably in the unit of one minute, one hour, or two hours. The index data serves as a starting screen upon playback; therefore, when the interval is too short with respect to the entire picture-recording time, the process thereof becomes complex, the amount of data becomes massive, and load is imposed on the monitoring/managing apparatus or the communication network. When the interval is too long, convenience upon playback is deteriorated. The difference detection interval is preferably one to three seconds. When the interval is too short, the amount of data becomes massive and load is imposed on the monitoring/managing apparatus or the communication network. When the interval is too long, insufficient monitoring/management is readily caused. For example, index data may be created every one hour, difference data may be created every three seconds, and they may be constantly stored from start to stop of the computer. Alternatively, they may be stored merely for a predetermined period of time, such as several hours, several minutes, or several seconds.

In detail, first of all, the control device of the monitoring/managing apparatus 100A requests connection with the terminal 200A to the communication control device of the monitoring/managing apparatus 100A (S101). The connection request includes ID data of the monitoring/managing apparatus 100A. When the communication control device of the terminal 200A receives the connection request, the control device of the terminal 200A accesses the authentication database to confirm that the person who requested the connection is a person who monitors/manages the terminal 200A by using the ID, and when it is confirmed, connection with the monitoring managing apparatus 100A is established by the communication control device (S102). When connection cannot be established, connection is requested again. The connection is requested the entire time during the picture-recording time that is determined by the environmental setting. As a result, even when connection is cut or the power supply of the terminal is turned off, monitoring/managing can be continuously carried out as soon as when the connection can be established. After picture-recording is started, the current time can be acquired by the clock function in the monitoring/managing apparatus to carry out picture-recording of the output screen of the terminal from certain time until certain time, and picture-recording can be stopped during the other time.

When connection is established, the control device of the monitoring/managing apparatus 100A carries out communication for requesting image data of the entirety of the output screen to the terminal 200A by the communication control device of the monitoring/managing apparatus 100A (S103). When the communication control device of the terminal 200A receives the request, the control device of the terminal 200A creates and records the image data of the entirety of the output screen of the terminal 200A in a bitmap format. In the case of RGB display, 1 pixel corresponds to 3 bytes. When the output screen has 1024 pixels in the transverse direction and 768 pixels in the vertical direction, the image data of the entire screen is 1024*768*3 bytes. Index data is created by adding data acquisition time information to the data. Since it is created as a still image in the bitmap format, the data size is small, and the load imposed on the terminal can be avoided.

The control device of the terminal 200A accumulates the created index data in the image folder (S105). Then, the control device of the terminal 200A compresses the index data and saves it as compressed index data in the image folder (S106). The compression is carried out by performing a process of omitting repeated data by adding the information of the repeated number of times to the information of the repetition started positions and color information. Then, the control device of the terminal 200A transmits the compressed index data to the monitoring/managing apparatus 100A by the communication control device (S107). As a result of compressing the still image in the bitmap format, the data size can be further reduced, and load imposed on the monitoring/managing apparatus, the communication network, or the terminal can be reduced.

The control device of the monitoring/managing apparatus 100A receives the compressed index data from the terminal 200A by the communication control device of the monitoring/managing apparatus 100A (S108). The control device of the monitoring/managing apparatus 100A creates a picture-recording file from the compressed index data, and the control device of the monitoring/managing apparatus 100A accumulates the file in the image folder (S110).

The control device of the monitoring/managing apparatus 100A acquires the current time by the clock function, accesses the environment-setting folder, and determines whether it is the picture-recording termination time (S111). When it is the picture-recording termination time, the control device of the monitoring/managing apparatus 100A terminates the picture-recording, and the screen returns to the second menu screen. Also, in the case in which the administrator selects picture-recording termination, the picture-recording is similarly terminated, and the screen returns to the second menu screen. When it is not the picture-recording termination time, similarly, whether it is picture-recording pausing time or not is then determined (S112). When it is the picture-recording pausing time, processing is paused until the picture-recording resuming time (S113); and when it is the picture-recording resuming time, the process returns to the step (S103) of performing communication for requesting image data. When it is not the picture-recording pausing time, similarly, whether it is index data creation time or not is then determined (S114). When it is the index data creation time, the process returns to the (S103) of performing the communication for requesting image data. When it is not the index data creation time, similarly, whether it is difference data creation time or not is determined (S115). When it is the difference data creation time, the communication for requesting difference data to the terminal 200A is carried out by the communication control device of the monitoring/managing apparatus 100A (S117). When it is not the difference data creation time, after processing is paused until the difference data creation time (S116), the communication is carried out. Since processing is paused other than data creation time, load imposed on the monitoring/managing apparatus can be reduced.

When the communication control device of the terminal 200A receives the difference data request from the monitoring/managing apparatus, the control device of the terminal 200A creates and records the image data of the entire output screen of the terminal 200A in the bitmap format (S118) and accumulates the image data in the image folder (S119). Then, the control device of the terminal 200A calculates difference data (S120).

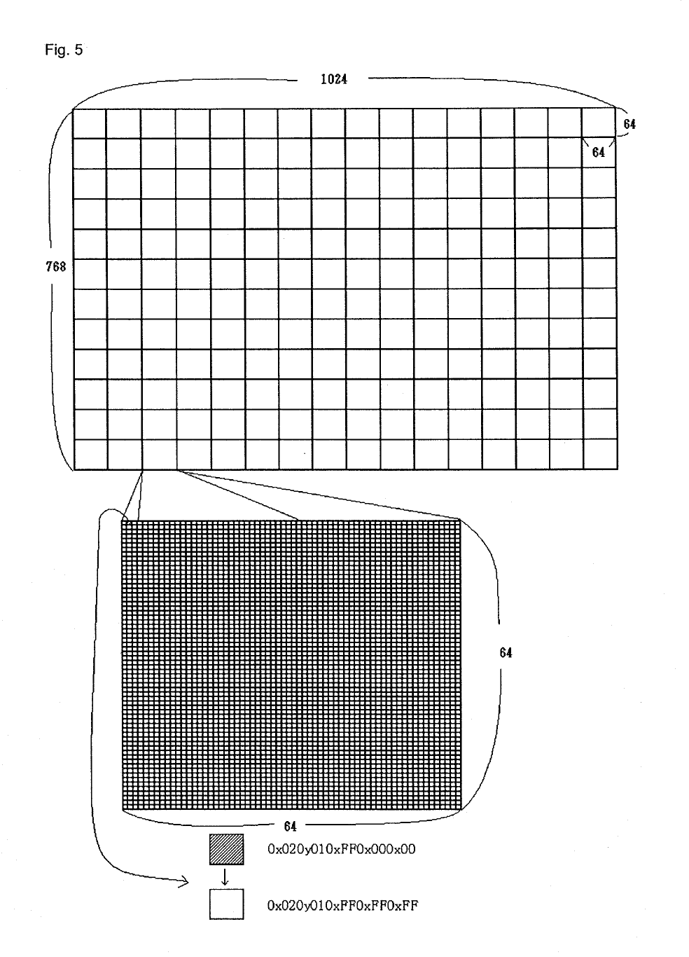

The difference data is calculated by comparing the screen still image that is recorded now with the full-screen still image (including index data) that is recorded immediately before. The control device of the terminal 200A individually divides the entirety of the full-screen still image that is accumulated in the image folder and recorded immediately before and the full-screen still image that is recorded this time into a predetermined number of sections, compares the respective sections of the former full-screen still image and those of the latter full-screen still image with each other in a section-to-section manner, and determines the presence or absence of change of the image data for each section. The number of pixels of one section can be set when the administrator inputs such information in <Environment Setting>, and it can be set so that one section has, for example, 32 pixels or 64 pixels both in the vertical and transverse directions. FIG. 5 is an explanatory diagram of an image recording method in the first embodiment of the system of the present invention. For example, when the output screen has 1024 pixels in the transverse direction and 768 pixels in the vertical direction, and when one section has 64 pixels both in the vertical and transverse directions, the screen is divided into 16 sections in the transverse direction and 12 sections in the vertical direction. One section has 64*64 pixels, and the image data of one pixel comprises position data and color data; and, for example, FIG. 5 shows the case in which, in the section that is the third section from the left and twelfth section from the top of the display, the pixel that is the second pixel from the left and the first pixel from the top therein is changed from red (image data: 0x020y010xFF0x000x00) to white (image data: 0x020y010xFF0x000xFF). The image data after the change is saved merely for the section having the pixels of which color data is changed. Upon saving, all the sections having the pixels of which color data is changed are put together, the position information and the difference data acquisition time information is added thereto, and it is saved as difference data. The image data of the sections not having the pixels of which color data is changed is not included in the difference data. In other words, the image data of merely the sections of which image data is changed is calculated to provide the difference data.

After the difference data is calculated, the full-screen still image that is accumulated in the image folder and recorded immediately before is discarded, and the full-screen still image that is recorded this time is accumulated in the image folder. This image is used for comparison with the full-screen still image that is recorded next time and discarded after difference data calculation. When there is no change in the output screen of the terminal 200A, difference data is not created. Also, a certain region may be set so that difference data is not created therefore, even when the image is changed. For example, in the output screen, a clock display part is excluded from difference calculation, and difference data is not acquired even when the image of the part is changed. As a result, management of the change that is not necessary for information management can be avoided to improve efficiency, and the data capacity needed can be reduced.

Then, the control device of the terminal 200A compresses the difference data by a normal compression method and saves the data as compressed difference data in the image folder (S121). Then, the control device of the terminal 200A transmits the compressed difference data to the monitoring/managing apparatus 100A by the communication control device (S122). Since it is the data of merely the difference and it is compressed, the data size is further reduced, and the load imposed on the communication network, the terminal, and the monitoring/managing apparatus can be avoided.

The control device of the monitoring/managing apparatus 100A receives the compressed difference data from the terminal 200A by the communication control device of the monitoring/managing apparatus 100A. The control device of the monitoring/managing apparatus 100A adds the compressed difference data to the picture-recording file accumulated in the image folder to update the file (S124), and the control device of the monitoring/managing apparatus 100A accumulates the file (S125). Then, the process returns to the step (S111) of determining whether it is the picture-recording terminating time or not.

(Playback Procedure)

The playback means, which opens the picture-recording file and displays the output screen images of the terminal sequentially in the output screen of the monitoring/managing apparatus, decompresses the picture-recording file comprising the compressed index data and the compressed difference data and performs playback wherein the output screen of the terminal from arbitrary index creation time until arbitrary time is sequentially displayed on the output screen of the monitoring/managing apparatus. Herein, “decompression” refers to the opposite of compression.

In detail, it is carried out in the following manner. When the administrator selects <Display Log> in the above-described second menu screen, the control device of the monitoring/managing apparatus 100A displays the index of the recorded image data on the display 104. The display may be carried out by window display or full-screen display. The index is displayed, for example, by year, month, date, and time. When selection is made in the index, the control device of the monitoring/managing apparatus 100A searches the picture-recording file, including the corresponding compressed index data from the image folder, decompresses the file, and sequentially displays the recorded image data on the display 104 so as to carry out playback of the contents displayed in the display 204 of the terminal 200A. The playback is carried out after the index data display by sequentially displaying the images to which the difference data is reflected at a predetermined interval. When the display interval is changed, fast-speed playback of a triple speed, five-times speed, or the like can be carried out. For example in the case of a triple speed, when the difference data is acquired every three seconds, the triple speed is realized by displaying the difference data on the display 104 at every one second by the control device of the monitoring/managing apparatus 100A.

(Remote Procedure)

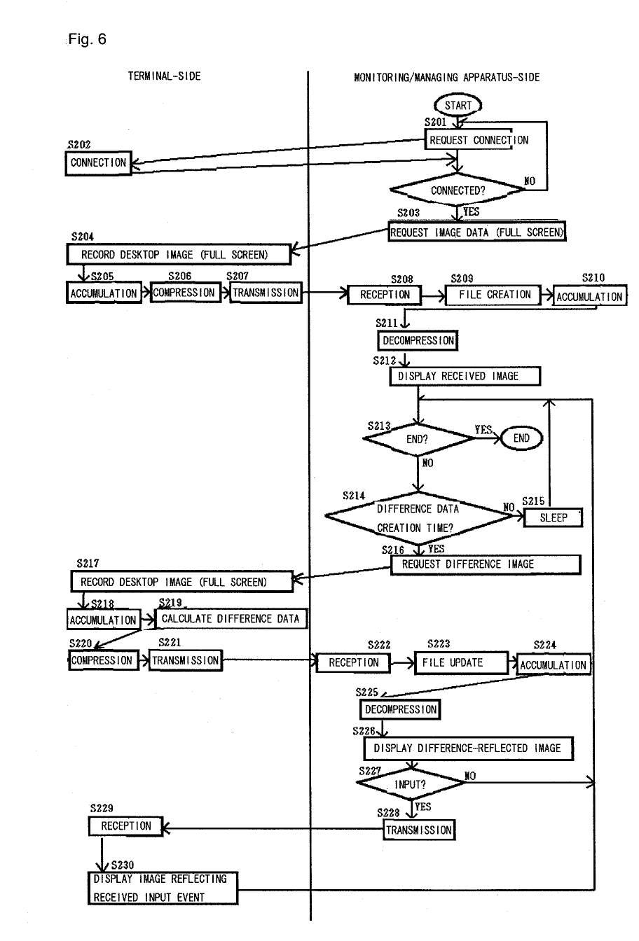

The terminal is remotely monitored/managed. In detail, it will be carried out in the following manner. FIG. 6 is a flow chart showing a remote procedure of the first embodiment of the system of the present invention. The system is for monitoring/managing information leakage from the terminals. When the administrator selects <Remote> in the above-described second menu screen, the monitoring/managing apparatus 100A and the terminal 200A cooperate, and in a manner similar to that described above S101 and S102, the communication means executes steps (S201 and S202) of connecting the monitoring/managing apparatus with the terminal. Then, in a manner similar to that described above S103 to S110, a step (S203 to S205) of recording and accumulating the image data of the entire output screen of the terminal by the index data creation means; a step (S206) of compressing and saving the index data by the compression means; a step (S207) of transmitting the compressed index data from the terminal to the monitoring/managing apparatus by the communication means; and a step (S208 to S210) of creating and accumulating a picture-recording file by the picture-recording file creation means by causing the monitoring/managing apparatus to receive the compressed index data by the communication means are executed.

The playback means, which opens the picture-recording file and sequentially displays the output screen images of the terminal on the output screen of the monitoring/managing apparatus, decompresses and opens the picture-recording file in the image folder (S211) and displays the index of the recorded image data on the display 104 (S212).

Then, the input event reflection means executes an operation order, which is input from the input unit of the monitoring/managing apparatus 100A, in the terminal 200A and carries out input event reflection outputting the result thereof to the output screen of the terminal 200A in real time. In more detail, it is carried out in the following manner.

When the administrator gives a remote terminating command by the input means, the control device of the monitoring/managing apparatus terminates the remote operation in accordance with the input command (S213). When there is no remote terminating command, the process proceeds to a step (S214) of determining whether it is difference data creation time or not.

In a manner similar to that described above S115 to S125, steps (S214 and S215) of determining whether it is data acquisition time or not by the time determination means, a step (S216) of requesting a difference image to the terminal by the communication means; a step (S217 to S219) of creating and accumulating the difference data of the output screen of the terminal at every difference detection time by the difference data creation means; a step (S220) of compressing and saving the difference data by the compression means; a step (S221) of transmitting the compressed difference data to the monitoring/managing apparatus from the terminal by the communication means; and a step (S222 to S224) of causing the monitoring/managing apparatus to receive the compressed difference data by the communication means and updating and accumulating the picture-recording file by the picture-recording file updating means, which adds the compressed difference data to the picture-recording file to update the file, are executed.

When the picture-recording file is updated, the playback means decompresses and opens the picture-recording file in the image folder (S225). By displaying the image to which the difference data is reflected on the display 104 in a manner similar to the procedure shown in the above-described playback procedure, the contents displayed on the display 204 of the terminal 200A are reproduced to the display 104 of the monitoring/managing apparatus 100A in real time (S226). The display may be carried out by window display or full-screen display.

When the administrator selects a playback image of the display 204 of the terminal 200A that is displayed on the display 104 and gives an input command by the keyboard or the mouse, which is an input means (S227), the control device of the monitoring/managing apparatus 100A transmits the input command event to the terminal 200A by the communication control device (S228). The control device of the terminal 200A, which has received the input command event, processes the received input command event as an input command event of the keyboard 205 or the mouse 206 is the input means of the terminal itself and displays the screen, to which the processing is reflected, on the display 204 of the terminal 200A (S229 to S230). Then, the process returns to the above-described S213.

Therefore, the contents displayed on the display 204 of the terminal 200A to which the input event in the monitoring/managing apparatus 100A is reflected are also displayed in the display 104 of the monitoring/managing apparatus 100A in real time.

(Search and Upload/Download Procedure)

The search means searches a file in the terminal 200A based on an operation order input from the input unit of the monitoring/managing apparatus 100A. Also, based on an operation order input from the input unit of the monitoring/managing apparatus 100A, the editing means carries out editing of copying or deleting a file in the terminal 200A, moving a file in the terminal 200A to an arbitrary region within the terminal or an arbitrary region in the monitoring/managing apparatus, or pasting a file in the terminal 200A to an arbitrary region within the terminal or an arbitrary region in the monitoring/managing apparatus. Also, based on an operation order input from the input unit of the monitoring/managing apparatus 100A, the editing means carries out editing of moving or pasting a file in the monitoring/managing apparatus 100A to an arbitrary region in the terminal 200A. Monitoring/management of the terminal is carried out by the above-described search and editing procedure. In detail, it is performed in the following manner.

When the administrator selects <Search and Upload/Download> in the above-described second menu screen, the monitoring/managing apparatus 100A and the terminal 200A cooperate, and in a manner similar to that of the step (S101 to S102) of the above-described picture-recording procedure, the monitoring/managing apparatus and the terminal are connected to each other. The control device of the monitoring/managing apparatus 100A requests a disk list of the terminal 200A from the communication control device of the monitoring/managing apparatus 100A. When the communication control device of the terminal 200A receives the request, the control device of the terminal 200A transmits the disk list data of the terminal 200A to the monitoring/managing apparatus 100A. When the communication control device of the monitoring/managing apparatus 100A receives the disk list data of the terminal 200A, the disk list of the terminal 200A and the disk list of the monitoring/managing apparatus 100A are displayed as icons by window display on the display 104.

When the administrator selects a disk icon or a folder icon of the terminal 200A among the displayed icons by the keyboard 105 or the mouse 106 while the disk list of the terminal 200A and the disk list of the monitoring/managing apparatus 100A are displayed, the control device of the monitoring/managing apparatus 100A requests the contents list of the selected disk or folder to the terminal 200A by the communication control device. When the communication control device of the terminal 200A receives the request, the control device of the terminal 200A transmits the contents list data of the disk or folder to the monitoring/managing apparatus 100A. When the control device of the monitoring/managing apparatus 100A receives the contents list data of the disk or folder of the terminal 200A, the device updates the disk list of the terminal 200A displayed in a window to icon display of the contents list of the disk or folder of the terminal 200A on the display 104.

When the administrator selects a file icon of the terminal 200A among the displayed icons and gives an input command of opening the file by double clicking or the like by the keyboard 105 or the mouse 106 while the icons of the contents list of the disks or folders of the terminal 200A are displayed, the control device of the monitoring/managing apparatus 100A requests transmission of the selected file to the terminal 200A by the communication control device. When the communication control device of the terminal 200A receives the request, the control device of the terminal 200A transmits the file data thereof to the monitoring/managing apparatus 1A. When the control device of the monitoring/managing apparatus 100A receives the file data, the device opens the file and subjects that to window display on the display 104.

Also, when the administrator selects a file icon of the terminal 200A among the displayed icons and drags the icon to the region of the disk list or the contents list of the disks or folders of the monitoring/managing apparatus 100A, which is displayed in a window by the keyboard 105 or mouse 106 while the icons of the contents list of the disks or folders of the terminal 200A are displayed, the control device of the monitoring/managing apparatus 100A requests transmission of the selected file to the terminal 200A by the communication control device. When the communication control device of the terminal 200A receives the request, the control device of the terminal 200A transmits the file data thereof to the monitoring/managing apparatus 100A. When the control device of the monitoring/managing apparatus 100A receives the file data, the device displays the file name in the selected region of the disk list of the monitoring/managing apparatus 100A and uploads and saves the file to the selected region of the monitoring/managing apparatus 100A.

When the administrator selects a file icon of the monitoring/managing apparatus 100A among the icons displayed and drags the icon to the region of the disk list or the contents list of the disks or folders of the terminal 200A that is displayed in a window by the keyboard 105 or the mouse 106 while the icons of the contents list of the disks or folders of the terminal 200A are displayed, the control device of the monitoring/managing apparatus 100A transmits the selected file to the terminal 200A by the communication control device. When the communication control device of the terminal 200A receives the file, the device downloads and saves the file to the selected region of the terminal 200A. The control device of the monitoring/managing apparatus 100A displays the file name thereof in the selected region.

### Advantageous Effects According to a First Embodiment of the Present Invention

In the present embodiment, by virtue of the above-described configuration, change of the screen of the terminal can be stored as still images, and the usage history of the terminal of a user can be reproduced as screen images as if a user at the remote monitoring/managing apparatus is sitting in front of the screen of the terminal. When information is leaked from the terminal, when and how the information is leaked can be checked. Moreover, when the system is introduced, because of the consciousness that the user is always monitored, the preventive effect with respect to information leakage, such as data exporting, is significantly large. Moreover, since new data is retrieved merely when display of the screen is changed, the capacity that is necessary for picture-recording of one-minute is 1 to 3 MB (megabytes), which is small compared with moving images, and the load imposed on the computer is small. Furthermore, display of the fact that picture-recording, playback, or search is carried out can be omitted in the display screen of the terminal, the terminal side is not provided with a means of deleting saved still images, and picture-recording cannot be stopped in the terminal side; therefore, the person who is using the terminal cannot control the system. Thus, monitoring and management can be reliably carried out. According to the present embodiment, change of the output screen can be stored as still images and sequentially reproduced as screen images, the capacity required for storage is small, and information management can be carried out by monitoring the output screen. Moreover, researching the history, such as information acquisition status and information leakage status in the terminal, deleting inappropriate files, and adding necessary files can be carried out in the monitoring/managing apparatus side; therefore, more detailed information management of the terminal can be carried out.

Preferably, an encrypting means of compressed data is loaded in the terminal, and a decrypting means is loaded in the monitoring/managing apparatus. Since it is encrypted, it cannot be reproduced by a normal image playback means, such as a media player, and it is safe in terms of security management. Moreover, the monitoring/managing status may be displayed in the terminal. In this case, the user thereof can grasp the monitoring/managing status, and leaking information can be psychologically prevented.

### Mode for the Invention 2

The second embodiment is for carrying out information management by monitoring the inside of an information processor and is effective, for example, in the case in which a plurality of persons share and use one computer. The computer is an information processor. It is also effective when a user is charged for viewing a site that the user has not viewed and when or how the user or sharing users operated is to be researched. It is also effective when information is leaked from the personal computer of a user, and when and how the information is leaked is to be researched.

### Configuration According to a Second Embodiment of the Present Invention

In the second embodiment, a system internally monitors and manages a computer wherein a communication means, an index data creation means, a difference data creation means, a compression means, a picture-recording file creation means, a picture-recording file updating means, and a playback means are provided in one computer.

In the present embodiment, a program of an information leakage monitoring/managing system of a computer of the present invention includes an output screen recording/control program and a monitoring/managing program, both of which are provided in the same computer.

The output screen recording/control program is a program for realizing, in the computer: a function of establishing connection with the computer itself; a function of receiving an output screen recording request; a function of recording the image of the entire output screen of the computer as a full-screen still image at a predetermined time interval and creating index data; a function of recording the image of the entire output screen of the terminal as a full-screen still image at a predetermined time interval, dividing a full-screen still image that has been just recorded and a full-screen still image that was recorded immediately before into a predetermined number of sections, and comparing them with each other; a function of determining the presence or absence of change of the image data for each section; a function of calculating the image data of merely the sections of which image data is changed and creating difference data; a function of compressing and saving the created index data; a function of compressing and saving the created differenced data; and a function of transmitting data.

The monitoring/managing program is a program for realizing, in the computer: a function of transmitting an output screen recording request; a function of receiving data; a function of creating a picture-recording file from the compressed index data; a function of adding the compressed difference data to the picture-recording file so as to update the file; and a function of opening the picture-recording file and sequentially displaying picture-recording images in the output screen of the computer.

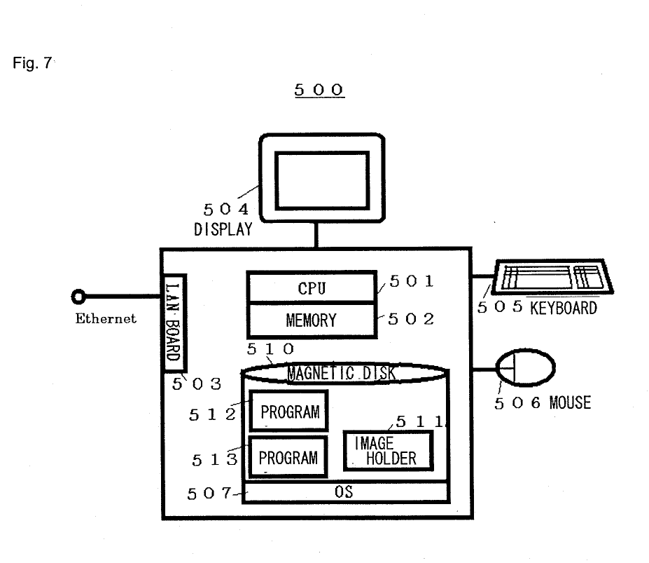

FIG. 7 is a configuration diagram of the second embodiment of the system of the present invention. The system is for monitoring/managing information leakage from the computer. In the present embodiment, a computer 500 is connected to a LAN, a WAN, or the Internet by a protocol called Ethernet. In order to carry out monitoring/management, access authority to the computer 500 is required. Authentication of the access authority is performed by an ID and a password.

The computer is recognized by a local IP address and a port number of the computer. The computer 500 is composed as a personal computer and provided with a clock function or the like that a normal personal computer has. The computer 500 comprises, as hardware, a control device comprising a CPU 501, a memory 502, a display 504, a keyboard 505, a mouse 506, an operating system 507, a device driver, and others, as well as secondary storage, such as a magnetic disk 510, and a communication control device, such as a LAN board 503. The magnetic disk 510 stores the monitoring/managing program 512, the output screen recording/control program 513, an image folder 511, an authentication database, and an environment-setting folder 511. In the image folder, output screen images, index data, difference data, compressed index data, compressed difference data, and picture-recording files are accumulated. In the authentication database, IDs and passwords are accumulated. In the database, port numbers and IP addresses for carrying out transmission/reception with the computer itself are accumulated, as well as IP addresses. In the environment-setting folder, setting conditions, such as index data creation intervals and difference data creation intervals of the output screen of the computer 500, the size for dividing images upon difference data creation, and so on are accumulated. The computer 500 realizes the functions of the computer that can carry out information leakage monitoring/managing processes of the present invention by loading the monitoring/managing program 512 and the output screen recording/control program 513 to the memory 502 and executing them by the CPU 501. The CPU 501 is an arithmetic processing unit, which is loaded on a normal computer, executes various programs, and performs various controls and other functions.

In the present embodiment, the computer 500 comprises: (1) a transmission means of transmitting a communication request including an operation request to the computer 500 and data; (2) a reception means of receiving the compressed index data and compressed difference data of the computer 500; (3) a picture-recording file creation means of creating a picture-recording file from the received compressed index data; (4) a picture-recording file updating means of adding the compressed difference data to the received picture-recording file to update the file; (5) a playback means of opening the picture-recording file and sequentially displaying the output screen images of the computer 500 in the output screen of the computer 500; (6) a reception means of receiving communication requests, including an operation request from the computer 500 and data; (7) an index data creation means of recording the image of the entire screen image of the computer 500 as a full-screen still image at every predetermined time; (8) a difference data creation means of recording the image of the entire output screen of the computer 500 as a full-screen still image at every predetermined time, dividing a full-screen still image that has been just recorded and a full-screen still image that was recorded immediately before into a predetermined number of sections, comparing them with each other, determining the presence or absence of change of the image data for each section, and creating difference data by summing up the image data of merely the section in which the image data is changed; (9) a compression means of compressing the index data and the difference data and saving them as compressed index data and compressed difference data, respectively; and (10) a transmission means of transmitting the compressed index data and the compressed difference data to the computer 500 in real time in accordance with an operation request from the computer 500. The computer 500 functions as above-described (1) to (10) means by the above-described hardware configuration, the monitoring/managing program 512, and the output screen recording/control program 513.

### Procedure According to a Second Embodiment of the Present Invention

The starting procedure, picture-recording procedure, and playback procedure of the second embodiment of the system of the present invention are approximately the same as the starting procedure, picture-recording procedure, and playback procedure of the above-described first embodiment. The present embodiment is the same as the above-described first embodiment except for the point that the hardware is not separated to the monitoring/managing apparatus and the computer, the point that connection confirmation and transmission/reception of data and requests are carried out between the monitoring/managing program and the output screen recording/control program in one computer by using the communication control device of the computer 500, and the point that in the playback means, the recorded image of the computer 500 is displayed in the display of the computer 500. In the present embodiment, the remote function and the search and upload/download function are not provided.

### Advantageous Effects According to a Second Embodiment of the Present Invention

In the present embodiment, by virtue of the above-described configuration, change of the screen of the computer can be stored as still images, and the usage history of the computer can be reproduced at the same computer as screen images as if a user is sitting in front of the screen at the recorded point. When information is leaked from the computer, when and how the information is leaked can be checked. Moreover, in the case in which one personal computer is used by a plurality of persons, when the system is introduced, because of the consciousness that the users are always monitored, the preventive effect with respect to information leakage, such as data exporting, is significantly large. Moreover, since new data is retrieved merely when display of the screen is changed, the capacity that is necessary for picture-recording of one-minute is 1 to 3 MB (megabytes), which is small compared with moving images, and the load imposed on the computer is small. According to the present embodiment, change of the output screen can be stored as still images and sequentially reproduced as screen images, the capacity required for storage is small, and information management can be carried out by monitoring the output screen.

### Mode for the Invention 3

In the third embodiment, in an operation manual creating/transmitting system that remotely supports one or a plurality of terminals by a monitoring/managing apparatus via a network, for example, with respect to computers of users at various locations connected to the network, a computer of an administrator, which is the supporter of these computers, creates an operation manual comprising a picture-recording file in which pictures of the operating record of the computer itself are recorded, and the computer of the administrator transmits such data to the computers of the users. The users can see the received operation manual on the screens of the computers of the users.

### Configuration According to a Third Embodiment of the Present Invention

The present embodiment is the operation manual creating and transmitting system. In the present embodiment, a communication means, an index data creation means, a difference data creation means, a compression means, a picture-recording file creation means, and a picture-recording file updating means are in the monitoring/managing apparatus that remotely supports the users, and a communication means and a playback means are provided in the terminals of the user side.

In the present embodiment, a program of the operation manual creating/distributing/viewing system includes a viewing program that operates in the terminals used by the users and a manual operation creating/distributing program that operates in the monitoring/managing apparatus used by the administrator.

The operation manual creating/distributing program is a program for realizing, in a computer: a function of transmitting/receiving data to or from the terminal; a function of recording the image of the entire output screen of the monitoring/managing apparatus as a full-screen still image at a predetermined time interval in accordance with a command from an input unit and creating index data; a function of recording the image of the entire output screen of the monitoring/managing apparatus as a full-screen still image at a predetermined time interval in accordance with a command from the input unit, dividing a full-screen still image that has just been recorded and a full-screen still image that was recorded immediately before, into a predetermined number of sections, and comparing them with each other; a function of determining the presence or absence of change of the image data for each section; a function of creating difference data by summing up the image data of merely the section in which the image data is changed; a function of compressing and saving the created index data; a function of compressing and saving the created difference data; a function of creating a picture-recording file from the compressed index data; and a function of updating the picture-recording file by addition of the compressed difference data to the picture-recording file.

The above-described viewing program is a program for realizing, in a computer: a function of transmitting/receiving data to or from the monitoring/managing apparatus and a function of opening the picture-recording file and sequentially displaying the picture-recording images in the output screen.

In the present embodiment, the monitoring/managing apparatus and the one terminal, or a plurality of terminals, are connected via a computer network. Both the monitoring/managing apparatus and the terminal(s) are composed as personal computers and provided with a clock function or the like that a normal personal computer has. The monitoring/managing apparatus comprises, as hardware, a control device comprising a CPU, a memory, a display, a keyboard, a mouse, an operating system, a device driver, and others, as well as secondary storage, such as a magnetic disk, and a communication control device, such as a LAN board. The magnetic disk stores the operation manual creating/distributing program, an image folder, and an environmental setting folder. In the image folder, output screen images, index data, difference data, compressed index data, compressed difference data, and picture-recording files are accumulated. In the environment-setting folder, setting conditions, such as index data creation intervals and difference data creation intervals, the size for dividing images upon difference data creation, and others are accumulated. The monitoring/managing apparatus realizes the functions of the computer that can carry out operation manual creation/distribution of the present invention by loading the operation manual creating/distributing program to the memory and executing it by the CPU. The CPU is an arithmetic processing unit, which is loaded on a normal computer, executes various programs, performs various controls, and so on.

The terminal has, as hardware, a control device comprising a CPU, a memory, a display, a keyboard, a mouse, an operating system, a device driver, and others, as well as secondary storage, such as a magnetic disk, and a communication control device, such as a LAN board. The magnetic disk stores the viewing program and an image folder. In the image folder, received picture-recording files are accumulated. The terminal realizes the functions of the computer that can carry out operation manual viewing of the present invention by loading the viewing program to the memory and executing it by the CPU. The CPU is an arithmetic processing unit, which is loaded on a normal computer, executes various programs, performs various controls, and so on.

Transmission and reception of mail is carried out by using the mail addresses of each other. Since authentication or the like is not required, an operation manual can readily be created, distributed, and viewed.

In the present embodiment, the monitoring/managing apparatus comprises: (1) a communication means of transmitting/receiving data to or from the terminal; (2) an index data creation means of recording the image of the entire output screen of the monitoring/managing apparatus as a full-screen still image at a predetermined time interval; (3) a difference data creation means of recording the image of the entire output screen of the monitoring/managing apparatus as a full-screen still image at a predetermined time interval, dividing a full-screen still image that has just been recorded and a full-screen still image that was recorded immediately before into a predetermined number of sections, comparing them with each other, determining the presence or absence of change of the image data for each section, and creating difference data by summing up the image data of merely the section in which the image data is changed; (4) a compression means of compressing the index data and the difference data and saving it as compressed index data and compressed difference data, respectively; (5) a picture-recording file creation means of creating a picture-recording file from the compressed index data; and (6) a picture-recording file updating means of updating the picture-recording file by adding the compressed difference data to the picture-recording file. The monitoring/managing apparatus functions as above-described (1) to (6) means by the above-described hardware configuration and the operation manual creating/distributing program.

Moreover, the terminal is provided with (1) a communication means of transmitting/receiving data to or from the monitoring/managing apparatus and (2) a playback means of opening the picture-recording file and sequentially displaying the output screen image of the monitoring/managing apparatus on the output screen of the terminal. The terminal functions as above-described (1) and (2) means by the above-described hardware configuration and the viewing program.

### Procedure According to a Third Embodiment of the Present Invention

An operation manual creating/distributing/viewing procedure of the third embodiment of the system of the present invention will next be described. The monitoring/managing apparatus can distribute an operation manual to a plurality of terminals at the same time.

First of all, the control device of the monitoring/managing apparatus displays a picture-recording starting screen in the display, which is an output screen, as an initial screen, and the control device accepts input from the administrator. When the administrator selects picture-recording start by the mouse or the keyboard, which is an input means, the operation manual creation is started. After the operation manual creation is started, first of all, the index data creation means, which records the image of the entire output screen of the monitoring/managing apparatus as a full-screen still image at a predetermined time interval, carries out a step of recording and accumulating the image data of the entire output screen of the monitoring/managing apparatus at every index creation time.

Then, the compression means, which individually compresses index data and difference data and saves it as compressed index data and compressed difference data, carries out a step of compressing and saving the image data.

Then, a step of creating and accumulating difference data of the output screen of the monitoring/managing apparatus at every difference detection time is carried out by the difference data creation means, which records the image of the entire output screen of the monitoring/managing apparatus as a full-screen still image at a predetermined time interval, divides a full-screen still image that has just been recorded and a full-screen still image that was recorded immediately before into a predetermined number of sections, compares them with each other, determines the presence or absence of change of the image data for each section, and creates difference data by summing up the image data of merely the section in which the image data is changed. In addition, the compression means carries out a step of compressing and saving the difference data, and the picture-recording file updating means, which adds the compressed difference data to the picture-recording file so as to update the file, carries out a step of sequentially updating and accumulating the picture-recording file.

The control device of the monitoring/managing apparatus carries out a step of acquiring the current time by the clock function, accessing the environment-setting folder, and determining whether it is data acquisition time or not. When pictures of operation record necessary for an operation manual are recorded, the administrator gives a picture-recording stop command by the input means. When the picture-recording stop command is received, in this step, the control device of the monitoring/managing apparatus stops the picture-recording function. When there is no picture-recording stop command, the current time is acquired by the clock function, access to the environment-setting folder is made, and whether it is index data creation time or not is determined. When it is the index data creation time, the process returns to the index data creation step. When it is not the index data creation time, whether it is difference data creation time or not is similarly determined. When it is the difference data creation time, the process returns to the difference data creation step. When it is not the difference data creation time, the process returns to the difference data creation step after processing is paused until the difference data creation time. As a result of pausing processing other than the data creation time, the load imposed on the monitoring/managing apparatus can be reduced.

After the picture-recording function is terminated, the communication means of transmitting/receiving data between the terminal and the monitoring/managing apparatus then carries out a step of transmitting the picture-recording file from the monitoring/managing apparatus to the terminal. Then, the reproduction means, which opens the received picture-recording file and sequentially displays the output screen images of the monitoring/managing apparatus on the output screen of the terminal, carries out a step of decompressing the picture-recording file comprising the compressed index data and the compressed difference data and sequentially displaying the operation manual, which is an operation record of the output screen of the monitoring/managing apparatus, on the output screen of the terminal.

Mail is used in the transmission/reception of data between the terminal and the monitoring/managing apparatus, and start and stop of picture-recording is carried out by the monitoring/managing apparatus that performs picture-recording; however, the steps of creation, compression, and saving of the index data and difference data at predetermined times are similar to those of the above-described first embodiment. Although creation/update of the picture-recording file is carried out in the monitoring/managing apparatus that carries out picture-recording, details of the step are similar to that of the above-described first embodiment. Although playback of the picture-recording file, in other words, viewing of the operation manual, is carried out in the terminal, details of the step are similar to that of the above-described first embodiment.

### Advantageous Effects According to a Third Embodiment of the Present Invention

The program of the system comprising the operation manual creating/distributing program and the viewing program causes the computers to execute the above-described steps. In the present embodiment, the functions of remote and search and upload/download are not provided.

Conventionally, in creation of operation manuals of software, long explanatory descriptions have been provided with illustrations of the screen of the part serving as points, and the resultant manual has been a thick paper medium, a CD-ROM, or a file downloaded from the Internet; therefore, users have been required to understand the operation by imaging the screen that is not shown and following descriptions; however, according to the present embodiment, all the screens corresponding to detailed operations can be recorded in images so that they can be reproduced as moving images; therefore, a detailed operation manual can be readily created. According to the present embodiment, change of the output screen can be stored as still images to provide an operation manual, the thus-created operation manual can be sequentially reproduced as screen images, and the capacity required for storage/transmission is small. The users using terminals can intuitionally understand the operation by virtue of the operation manual, which is excellent in convenience.

It should be noted that the present invention is not limited to the above-described embodiments, and the various modifications can be made without deviating from the scope of the present invention. Also, the constituent elements of the above-described embodiments can be arbitrarily combined without deviating from the scope of the present invention.

### INDUSTRIAL APPLICABILITY

This invention can be applied to, for example, monitoring and managing the operation state, information input/output state, and so on of personal computers of company members at various locations connected by a network by an administrator.

1. A system comprising: a plurality of terminals and a monitoring/managing apparatus, which the monitoring/managing apparatus remotely monitors and management-controls the terminals via a network for monitoring/managing information leakage from the terminals;
said terminal comprising: an index data creation unit that records an image of an entire output screen of the terminal as a full-screen still image at every index creation time and creates index data from the full-screen still image;
a difference data creation unit that records an image of the entire output screen of the terminal as a full-screen still image at every difference detection time, divides a full-screen still image that has just been recorded and a full-screen still image that was recorded immediately before into a predetermined number of sections and compares the respective sections with each other, determines the presence or absence of change in the image data of each section, and merely for the section in which the image data is changed, creates difference data of all the sections in which the image data is changed, the difference data having the image data of the section after the change, position information of the section, and data acquisition time information; and a compression unit that compresses the index data and the difference data and saves them as compressed index data and compressed difference data, respectively;
said monitoring/managing apparatus comprising: a communication unit that transmits/receives data and transmits an operation request merely in one direction from the monitoring/managing apparatus to the terminal; a picture-recording file creation unit that creates a picture-recording file for the every-compressed index data transmitted from the terminal to the monitoring/managing apparatus;
a picture-recording file updating unit that updates the picture-recording file by addition of the compressed difference data to the received picture-recording file, which is transmitted from the terminal to the monitoring/managing apparatus, to the picture-recording file so as to update the file; and a playback unit that opens the picture-recording file and displays the output screen images of the terminal sequentially on the output screen of the monitoring/managing apparatus at one speed chosen from a plurality of display speeds by adjusting the display intervals; and
said index data creation unit and said difference data creation unit starting processing based on the operation request.

2. The system according to claim 1, wherein the terminal further comprises an input event reflection unit that causes the terminal to execute an operation order input from an input unit of the monitoring/managing apparatus and outputs a result thereof to the output screen of the terminal in real time.

3. The system according to claim 1, wherein the monitoring/managing apparatus further comprises a searching unit that searches a file in the terminal based on an operation order input from the input unit of the monitoring/managing apparatus and an editing unit that edits a file in the terminal based on an operation order input from the input unit of the monitoring/managing apparatus.

4. A monitoring/managing method for remotely monitoring and management-controlling a plurality of terminals via a network for monitoring/managing information leakage from the terminals, comprising the steps of:
transmitting an operation request from a monitoring/managing apparatus to a terminal by a communication unit;
recording an image of an entire output screen of the terminal as a full-screen still image at every index creation time and creating index data from the full-screen still image by an index data creation unit;
compressing the index data by a compression unit, and saving result of said step of compressing the index data as compressed index data;
creating a picture-recording file for every-compressed index data transmitted from the terminal to the monitoring/managing apparatus;
recording an image of the entire output screen of the terminal as a full-screen still image at every difference detection time by a difference data creation unit;
dividing a full-screen still image that has just been recorded and a full-screen still image that was recorded immediately before into a predetermined number of sections and comparing the respective sections with each other, determining the presence or absence of change in the image data of each section, and creating difference data of all the sections in which the image data is changed, the difference data having the image data of the section after the change, position information of the section, and data acquisition time information;
compressing the difference data by the compression unit, and saving result of said step of compressing the different data as compressed difference data;
updating the picture-recording file by addition of the compressed difference data to the received picture-recording file, which is transmitted from the terminal to the monitoring/managing apparatus; and
opening the picture-recording file and displaying the output screen images of the terminal sequentially on the output screen of the monitoring/managing apparatus at one speed chosen from a plurality of display speeds by adjusting the display intervals;
wherein said step of recording an image of an entire output screen of the terminal as a full-screen still image at every index creation time, and said step of recording an image of the entire output screen of the terminal as a full-screen still image at every difference detection time includes starting processing based on the operation request.

5. The monitoring/managing method according to claim 4, further comprising the steps of operating the terminal by an operation order input from an input unit of the monitoring/managing apparatus and outputting a result thereof to the output screen of the terminal in real time.

6. The monitoring/managing method according to claim 4, further comprising the steps of searching a file in the terminal based on an operation order input from an input unit of the monitoring/managing apparatus and editing a file in the terminal based on an operation order input from the input unit of the monitoring/managing apparatus.
